(19) United States
(12) Patent Application Publication
(10) Pub. No.: US 2012/0221426 A1
(43) Pub. Date: Aug. 30, 2012

(54) MARKETPLACE AUCTION SYSTEM AND METHOD FOR PURCHASING MEETINGS AND EVENTS

(76) Inventor: Emilie Chang Ho, Old Greenwich, CT (US)

(21) Appl. No.: 13/245,631

(22) Filed: Sep. 26, 2011

Related U.S. Application Data
(60) Provisional application No. 61/386,212, filed on Sep. 24, 2010.

(51) Int. Cl. G06Q 30/08

(52) U.S. Cl. 705/26.3

(57) ABSTRACT

An auction system has a platform accessible by a number of companies that place meetings up for bids to buy side firms that wish to invest in the companies. A company determines the parameters for the received bids, including selecting and ranking factors to be considered for the bids. The company also assign weights to emphasize those factors important in submitted the bid. Buy side firms submit bids and provide information relating to the factors. A winning bid is determined, and payment received to purchase the meeting.

### FIELD OF THE INVENTION

The present invention relates to an auction system that allows users to bid on meetings and conferences with interested companies. More particularly, the present invention relates to a secure electronic marketplace system and associated methods that allow users to bid directly on conferences and meetings with targeted companies across networks or other associated data exchange systems.

### BACKGROUND

Currently, relationships exist between various entities in the financial markets. The following background discussion primarily refers to the equities market, but may pertain to relationships in other markets, such as fixed income, derivatives, private equity and the like. In these markets, investing entities pay fees and commissions to have access to and meet with companies of interest. The fees and commissions go to a third party that arranges such meetings.

A buy side firm may be a financial institution, such as a professional investment group. A buy side firm may be a business that invests money for others and receives payment for its efforts. The buy side firm may be any type and size, and may manage thousands to billions of dollars. A buy side firm manages money for pension funds, endowments, foreign governments, individuals and the like.

A characteristic of a buy side firm is buying services from a sell side firm. A sell side firm also may be any type and size entity. For example, a sell side firm may range from a very large multi-national, well-known corporation, such as Goldman Sachs™ or JP Morgan™, to one of thousands of smaller independent firms. A sell side firm receives compensation, or payment, from a buy side firm for the services it sells.

The services provided by a sell side firm include various financial and investment services. The services include helping a buy side firm execute trades, receiving the sell side firm's expertise in providing investment advice, or using the sell side firm to access management at the individual companies in which the buy side firm is considering an investment. The sell side firm then receives a payment for their services from the buy side firm. This payment is typically representative of bundled services; that is, the buy side firm is required to pay for all of the services provided, regardless of what the buy side firm actually wants or uses.

Payment for the services of the sell side firm comes in different forms. Payment may be direct, but the most common payment is by commission, especially to a larger sell side brokerage. In other words, whenever the buy side firm buys or sells a security, the sell side firm charges a commission on the trade. For equity securities, the commission may range from 3 to 5 cents per share. Thus, if the buy side firm sells 100,000 shares of stock XYZ at $0.04 per share, then the buy side firm pays $4000.00 in commission to the sell side firm.

A buy side firm budgets an amount for the commissions anticipated to pay the sell side firms with whom a relationship exists. The size of this budget may depend on the amount of assets the buy side firm has under management and on the rate at which the buy side firm trades its portfolio. For example, a buy side firm with $1,000,000,000 in assets may set aside $10,000,000 annually for commissions. In aggregate, hundreds of millions of dollars may be paid to sell side firms for their services.

A sell side firm provides “value added” services to buy side firms. These services typically fall into one of the following groups: research, sales, trades or corporate access. These services are discussed in greater detail below.

Larger sell side firms employ sizeable research groups that perform research, analysis and make stock recommendations on the companies they examine. A large brokerage firm may use up to 70 analysts to research hundreds and hundreds of stocks. The sell side firm assigns a team of analysts to cover a sector, such as retail, energy, technology and the like. The team, in turn, produces recommendations that investors buy, sell or hold a particular stock based on their research. The research encompasses following the targeted company closely in the news, creating models to predict future earnings and interacting with the targeted company to better understand its business. The team of analysts also spend time interacting with buy side firms, educating institutional investors, sharing information or comparing notes.

A sell side firm also adds value through their research sales teams. A sales person serves as the primary point of contact for a buy side investor. The teams are charged with disseminating information from the sell side firm to their client in a timely manner. The teams also filter out any extraneous information, make sound stock recommendations to their client, and, ultimately, foster a relationship between the sell side firm and their institutional client to become a trusted advisor for the buy side firm.

A sell side firm also executes trades as a brokerage for their clients. The sell side firm tries to add value by providing better execution of the trades. In other words, the sell side firm uses its experience and expertise to buy stocks at a lower price or sell stocks at a higher price on behalf of their customers, such as the buy side firm. This ability is predicated on a trader having good information flow on where to find pools of liquidity on a given name or knowing up-to-date information on the myriad of issues that impact how a security will trade.

A sell side firm also adds value through their corporate marketing efforts. Corporate marketing appears as a simple proposition, but is an important piece of business to a sell side firm. The corporate marketing group at a sell side firm sets up meetings for companies, usually publicly traded, with institutional investors. The companies receive an audience with potential investors and institutional investors, or buy side firms, receive an opportunity to meet face-to-face with the management of the companies.

Corporate marketing events may fall into “deal” and “non-deal” categories. Deal-related events refer to those meetings that a corporate management team hosts in furtherance of a capital raising or other seminal event. For example, if company XYZ files to hold an initial public offering of stock, then the upper management of XYZ will allow the sell side firms underwriting the deal to arrange meetings with potential investors.

When the company decides to sell additional stock in a “secondary” offering, then the underwriters often arrange meetings with both existing shareholders and potential new shareholders in an effort to get the buy side firm to purchase securities. Company mergers and acquisitions also create deal-related roadshows as management seeks to convince existing shareholders to ratify the proposed transformational event.

Non-deal events represent every other type of corporate marketing activities. These events may consist of a sell side research analyst taking a trip to a company's headquarters to meet management as a routine part of his or her duties. Often, the analyst may invite several buy side firm representatives. Sell side firms also host research conferences in which they invite companies in related industries, such as technology or health care, to host investor presentations. Research conferences can be large multi-day affairs hosted at world-class destination resorts that bring together many companies and a large number of buy side investors. Conferences also may be more subdued events, lasting for a morning or afternoon, with presentations from a few companies in similar industries or focused on a similar theme. In most of these situations, the smaller the ratio of buy side firms to management, the more coveted the slot becomes to a buy side firm.

Outside of these investor conferences, sell side firms also provide corporate access through non-deal roadshows. These roadshows consist of company management traveling to a city or series of cities to meet with shareholders or potential shareholders. Most public corporations commit to spending a certain number of days per quarter or year engaged in non-deal roadshows, understanding that the time spent meeting with current or potential investors is productive. As a result, sell side firms work very hard to persuade these companies to allow the sell side firm's corporate marketing team to “host” a non-deal roadshow marketing day.

A sell side firm uses a variety of means to capture these events, such as relationships cultivated by the firm's research analyst, relationships driven by the firm's investment or commercial bank, and relationships developed by the corporate marketing team. Once the sell side firm is able to secure a marketing day, it will reach out to their clients to set up meetings. The sell side firm typically allocates these meetings to their best clients. While the sell side firm will take into consideration many factors, such as whether the buy side firm is a current shareholder, ultimately, the sell side firm disproportionally relies on the commission dollars paid by the buy side firm to arrange these meetings. This scenario prevails especially in those situations when a significant demand for the meetings exists.

These meetings clearly are valuable to a buy side firm because a buy side firm may spend one-third of their commission budget for the meeting's arrangement. Many institutional investors insist on meeting with management prior to making an investment and use the meetings as a forum to judge a management's team credibility.

As noted above, these meetings serve a vital role for buy side firms and sell side firms, both in opportunities and expenses. Despite the large sums of money exchanged, the connection of corporate management with buy side firms does not occur in a rational environment. Instead, sell side firms work in an inefficient and opaque marketplace, wherein the buy side firms are unable to fully understand the price of the services they seek. Further, many worthy buy side firms are denied access to these meetings because of their level of relationship with a particular sell side firm or the inability to pay the large commissions/fees charged by sell side firms.

### SUMMARY OF THE INVENTION

According to the disclosed embodiments, a computer implemented marketplace auction system allows for companies to bid for meetings with other companies for investment or informational purposes. The computer implemented marketplace auction system includes at least one buy side firm registered to access an auction platform. The computer implemented marketplace auction system also includes at least one company registered to offer a meeting on the auction platform. The computer implemented marketplace auction system also includes an auction process supported by the auction platform. The at least one buy side firm places a bid to purchase the meeting with the at least one company. The computer implemented marketplace auction system also includes an account configured to receive payment for the bid upon completion of the auction.

According to the additional embodiments, a computer implemented method for purchasing meetings between a buy side firm and a company in which the buy side firm invests is disclosed. The computer implemented method includes selecting an auction for a meeting with the company. The computer implemented method also includes placing a bid via an auction platform by the buy side firm. The bid pertains to the meeting such that the buy side firm desires to purchase the meeting with the company. The computer implemented method also includes indicating to the buy side firm whether the bid is rejected, too low or a new current bid. The computer implemented method also includes notifying the buy side firm whether the meeting has been purchased upon completion of the auction after a period of time. The computer implemented method also includes receiving payment of the bid if the meeting has been purchased.

According to additional embodiments, an auction method for purchasing meetings within a system of companies and buy side firms is disclosed. The auction method includes receiving a plurality of bids for a meeting with a company. The bids are submitted by a respective plurality of buy side firms. The auction method also includes compiling information associated with at least one factor for each of the plurality of bids. The information is stored with linked computing devices or provided by each of the plurality of buy side firms. The auction method also includes determining a bid value for each of the plurality of bids based on the bid, the at least one factor, and the compiled information. The auction method also includes, upon completion of the receiving step after a period of time, notifying a buy side firm that the meeting has been purchased based on the bid value. The auction method also includes receiving payment associated with the bid value if the meeting has been purchased.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a marketplace auction system for facilitating meetings between buy side firms and companies according to the disclosed embodiments.

FIG. 2 illustrates a flowchart of a process flow for a sign-in page according to the disclosed embodiments.

FIG. 3 illustrates a flowchart of a process flow for a home page according to the disclosed embodiments.

FIG. 4 illustrates a flowchart of a process for an auction page according to the disclosed embodiments.

FIG. 5 illustrates a flowchart of a process for a checkout page according to the disclosed embodiments.

FIG. 6 illustrates a flowchart for determining a bid value according to the disclosed embodiments.

### DESCRIPTION OF THE DISCLOSED EMBODIMENTS OF THE INVENTION

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

The disclosed embodiments of the present invention provide a unique value proposition to investors, such as buy side firms, by addressing many of the flaws in the current business model, as described above. The disclosed embodiments create an open auction marketplace for investors, such as buy side firms, and provides a transparent method for investors to bid for and purchase meeting with corporate clients. Currently, sell side firms, such as investment banks, orchestrate these meetings and direct meetings to the firms' top clients. Decisions about meeting allocations are made in a vacuum by marketing groups that have little or no knowledge of the buyer side firm's goals or objectives. As a result, top clients are overscheduled and waste time meeting with companies they have little interest in making an investment. Conversely, other buy side firms that desperately want to meet a certain company often are shut out of the process because those firms do not pay enough commissions to the sell side firm.

By allowing investors to bid for any meeting on the disclosed system, the disclosed embodiments level the playing field for buy side firms, or investors, and the companies needing investment capital. Hedge funds, pension funds and mutual funds of all sizes have an equal opportunity to bid for and purchase any meeting based on what is most important to their investment strategy. The buy side firms choose what meetings to bid on, how much to bid and when, where and how they would like to meet. By the end of the disclosed meeting auction, the disclosed process establishes a market-clearing price for any particular meeting. The market-clearing mechanism eliminates much of the favoritism and opacity created by sell side firms, such as Wall Street brokerages.

The disclosed embodiments also reduce the need to pay for unnecessary resources provided by a sell side firm. An investor in a buy side firm avoids paying for the whole “bundle” of services that the sell side firm provides. If a buy side firm finds little value added by a sell side firm research department, a trading desk or other bundled services, then the buy side firm does not need to pay for it. The disclosed embodiments allow the buy side firm to bid for and purchase exactly those services that meet its needs. By only bidding for what is most important to its business, the buy side firm maximizes its dollars spent for corporate access.

The disclosed embodiments also allow the buy side firm to track how much it spends specifically on corporate access. A buy side firm can accurately track how much it spent for a particular investment. A buy side firm can calculate its true return on investment, while showing its clients how management fees are spent.

Moreover, the disclosed embodiments include a network and platform that provides an efficient means of maximizing the investment professional's time and money. The platform of the disclosed embodiments ideally is suited to take advantage of the burgeoning era of video conferencing. Buy side firms, as investors, can now choose to bid on either face-to-face meetings or videoconference meetings. By choosing only videoconference meetings, the buy side firm eliminates unnecessary travel to and from meetings.

The disclosed embodiments also provide multiple benefits to corporate clients. A buy side firm typically spends one-third of their commission budgets, which is frequently worth millions of dollars, for corporate access. These fees currently are paid to the sell side firm, such as an investment bank, that receives a windfall for management's time spent with the investors. According to the disclosed embodiments, a corporation is able to create real value with the time spent by its most senior managers.

In one embodiment, all or a portion of the auction proceeds, less a transaction fee paid to the administrator of the disclosed system, maybe transferred seamlessly to a philanthropic cause of the bidder's choosing. According to the disclosed embodiments, significant sums of money, which formerly went to sell side firms on Wall Street, are available to serve the greater good and support a bidder's philanthropic objectives. In another embodiment, a company also may keep a portion of the proceeds, thereby adding directly to its bottom line. In still another embodiment, the auction administrator can retain a greater share of the auction proceeds.

As an added benefit, the disclosed embodiments include a videoconferencing solution that does not require travel to and from meetings by senior management. This eco-friendly approach reduces the company's carbon footprint while maximizing the manager's or management team's time. The management team may travel for corporate marketing purposes multiple times a year as each of the investment banks vie for their time. By offering face-to-face and videoconference meetings, management teams host more meetings with less travel.

A typical investor road show arranged by a sell side firm, for example, may result in 5 one-on-one meetings and a group lunch. In total, the management team may see about 6 to 10 investors in a full day of meetings. Videoconferencing allows management teams to see an equal or greater number of investors in a shorter timeframe. This benefit enables management teams to spend their resources and energy focusing on strategy and running their business. In addition, the disclosed embodiments allow the management team to market on short notice and whenever it is convenient for the team, as opposed to relying on sell side firm sponsorship.

Under the disclosed process and system, a management team of a public company agrees to meet with investors in order to educate and inform these entities on the company's strategy and opportunities. In turn, the management team hopes the investors will buy and hold the company's stock. One important aspect of the marketing process is to obtain feedback from potential and current investors regarding the management team's strategy. Currently, a sell side firm, such as an investment bank, filters the feedback to the company, or may not provide any feedback at all.

By using the platform disclosed below, investors can give immediate suggestions directly to the management team via an online feedback form. The feedback is available immediately following a meeting and saved for the management team to review. This information may be valuable to a management team that wants to know how the company is doing in the eyes of its top shareholders. By eliminating the sell side firm, or, in other words, the middle man, management teams are able to directly interface with investors.

In addition, security is required by both investors and corporate management teams. The disclosed embodiments use industry leading authentication and security standards to protect clients' identities and data. The disclosed embodiments authenticate investors and corporate clients via the registration and sign-in process. Further, payment for using the system of the disclosed embodiments is simple and easy to use. Transactions can be charged easily to a credit card or prepaid via a client service agreement (CSA).

The disclosed embodiments create a one of a kind market-based approach that revolutionizes corporate marketing. A secure electronic marketplace is created for investors to bid and/or purchase meetings with company executives. The disclosed embodiments differ from the current approaches, where sell side firms arrange and orchestrate such meetings. Investors, or buy side firms, benefit because the disclosed embodiments allow these entities to target their commission dollars for the corporate access that is most important.

Buy side firms also are afforded the opportunity to provide feedback directly to management of the companies and to track the return on their investments. The disclosed system and platform also provides face-to-face and videoconferencing meetings, thereby maximizing the number of meetings while eliminating travel costs and time for both parties.

Corporate clients can benefit from the proceeds generated by the meetings or choose to donate the proceeds to charity. Management teams can meet with any investor via videoconference without the time and expense of travel. The feedback loop between the investor and the company can occur directly with greater frequency. The disclosed embodiments revolutionize the corporate marketing process, which benefits investors and companies in a manner not found in the current state of the art.

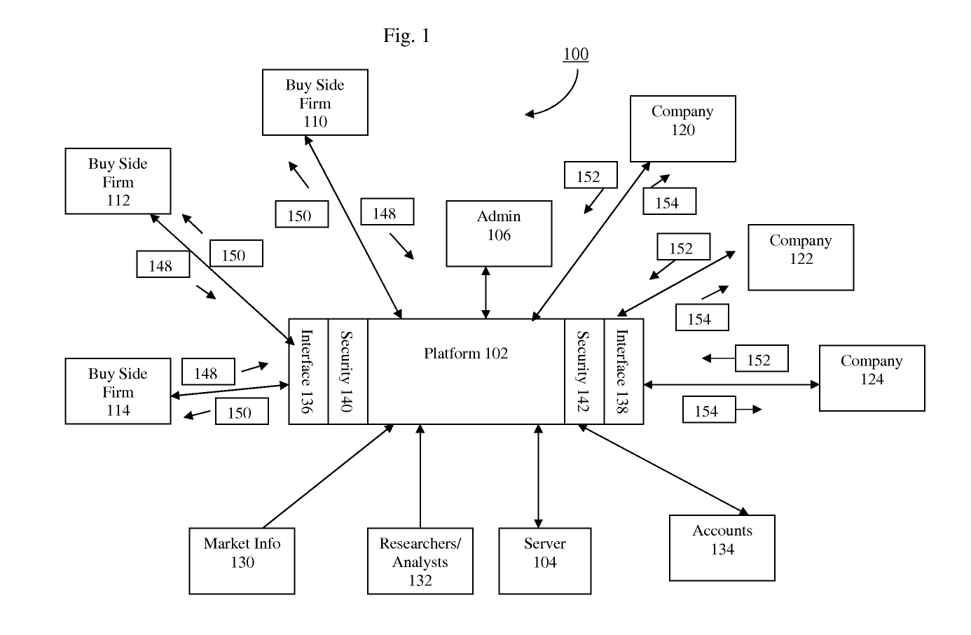

FIG. 1 illustrates a marketplace auction system 100 for facilitating meetings between buy side firms 110-114 and companies 120-124 according to the disclosed embodiments. As disclosed above, buy side firms 110-114 and companies 120-124 desire to meet with each other to discuss potential investing opportunities and build business relationships. System 100 may be implemented over a network of computer/machines coupled to each other. This network may be a secure, encrypted network accessible only by those entities authorized to be on system 100.

Platform 102 serves as the engine for system 100 by hosting and providing the auction process accessible by buy side firms 110-114 and companies 120-124. Platform 102 may include software, hardware, including a processor and memory, which executes programs and instructions to perform the auction process disclosed in greater detail below. In an embodiment, platform 102 is a computing device or plurality of computing devices linked to operate as a supporting architecture for the process. The instructions for the process may be stored on platform 102 or within server 104, accessible by platform 102. Further, server 104 may act as storage for results of auctions executed by platform 102. Server 104 also may represent a plurality of servers that store data for system 100, such that the servers are linked together via a network as well.

Administrator 106 also accesses platform 104. Administrator 106 may be another computer or a user that updates and performs routines maintenance on the components of platform 102. Administrator 106 also may control access by buy side firms 110 and companies 120, and performs the diligence required to allow these firms and companies access to system 100. Server 104 and administrator 106 may reside in the same location as platform 102, or may be remote such that operations are conducted apart from the management of system 100. For example, programmers and support personnel may access platform 102 via administrator from one location, such as a headquarters, while server 104 and platform 102 are located in a less densely populated area to save on costs, space and the like.

Platform 102 hosts auctions to arrange meetings between investors and public companies seeking to meet with such investors. Buy side firms 110-114 register for access to a website associated with platform 102. The website may serve as a portal to third parties to execute the auction process or review bids. Buy side firms 110-114 then may search the website for companies 120-124 that fit their criteria or interest. Buy side firms 110-114 may go to auction webpages and perform other functions, which are disclosed in greater detail below.

In one embodiment, the auction administrator is responsible for accessing the system 100 so that companies 120-124 are made available for meetings. In this embodiment, the companies 120-124 may also contact potential buy side firms 110-114 via the auction operator. Then, the auction administrator may post meetings, either face-to-face or videoconference, that they would like to have, and include parameters for such meetings, such as investment dollars desired, industry, location, government regulations and the like. In another embodiment, companies 120-124 may access platform 102 within system 100 to make themselves available for meetings. In this embodiment, companies 120-124 also may search and contact potential buy side firms 110-114 that may invest. In this embodiment, companies 120-124 may also post meetings, either face-to-face or videoconference, that they would like to have, and include parameters for such meetings, such as investment dollars desired, industry, location, government regulations and the like.

Buy side firms 110-114 use interface 136 to interact with platform 102. Interface 136 may be a webpage or homepage for specific use by a specific buy side firm, such as buy side firm 110. Software or other security means may enable interface 136. Alternatively, buy side firm 110 may use a device that allows access to platform 102, such as a peripheral component interconnect device. In any event, interface 136 communicates and exchanges information with buy side firms 110-114. Preferably, interface 136 supports graphical user interfaces that exchange information with a buy side firm. Security layer 140 provides an extra layer of security to platform 102, and may include encryption/decryption methods to communicate in a secure manner.

For companies 120-124, interface 138 may provide the same functions as interface 136, except tailored for those companies looking to accept meeting bids from buy side firms 110-114. Security layer 142 also provides an extra layer of security to platform 102. Interfaces 136 and 138, and security layers 140 and 142 may reside on platform 102, but do not interfere with the actual auction process of system 100. Administrator 106 may change, add or remove these components from platform 102, as desired. Alternatively, platform 102 may not incorporate any of these elements.

Other elements within system 100 also access platform 102 to provide buy side firms 110-114 and companies 120-124 with information or services beyond auctions. For example, market information 130 may be current stock information or market conditions that might be of interest to clients of system 100. Such information may be available from public sources that provide current financial information. Buy side firms 110-114 can set indicators to have such information available on auctions bid upon.

Researchers/analyst information 132 may provide information generated by support personnel on behalf of buy side firms 110-114, companies 120-124 or any other entity to give detailed analysis requested by a user of system 100. Corporate information may be made available as part of an auction or at the request of a bidder.

Accounts 134 may pertain to banking accounts accessible by platform 102 to complete transactions and to deposit money earned during the auction process. Accounts 134 also may be those accounts receiving proceeds as charitable contributions.

Buy side firms 110-114 may send information or data to platform 102 within packet 148 and receive information or data within packet 150. Companies 120-124 may do the same with packets 152 and 154. These packets may be encrypted at the buy side firm or companies, and decrypted by interfaces 136 and 138. The information or data sent within system 100 may include feedback forms or other communications between parties beside auction bids and notifications. System 100 may assign every registered entity its own unique identification name, and messages are routed to the entity based on the name.

If a videoconferencing option is selected by the parties to an auction, then administrator 106 may set that up via system 100. Platform 102 may host the videoconference as it may provide the requisite security for both parties to communicate. Further, this option alleviates the need for a winning buy side firm and a company to integrate their individual systems.

Buy side firms 110-114 and companies 120-124 also include computers, servers, or any computing device that stores information and executes instructions. In other words, platform 102 may access information about these entities by establishing a link over system 100 to retrieve such information during a bidding process. Other elements of system 100 also include computing devices that are accessible by platform 102.

During an auction, platform 102 receives a bid and then compiles information pertaining to the bid, as disclosed in greater detail below. Platform 102 accesses the network supporting system 100 to connect to the associated buy side firm computing devices to retrieve information desired in evaluating the bid. Platform 102 also may access information in computing devices for companies 120-124 that indicates various factors to be considered in the bidding process. Moreover, platform 102 may access third party locations to retrieve information, especially negative or objective data on any submitting buy side firm.

The disclosed embodiments are not limited to these elements of FIG. 1 for system 100. Any number of buy side firms and companies may access platform 102. Further, additional platforms may be added as needed to handle a large number of auctions. Other information also may be available.

The software code or associated instructions to support the features of system 100 and the process disclosed below may be deployed by manually loading directly in the client, server and proxy computers via loading a storage medium such as a CD, DVD, and the like. The software code or instructions also may be automatically or semi-automatically deployed into system 100 by sending the software to server 104 or a group of central servers. The software is downloaded into the client computers that will execute the process software. Alternatively the process software is sent directly to throughout system 100 via e-mail. The software is either detached to a directory or loaded into a directory by a button on the e-mail that executes a program that detaches the process software into a directory.

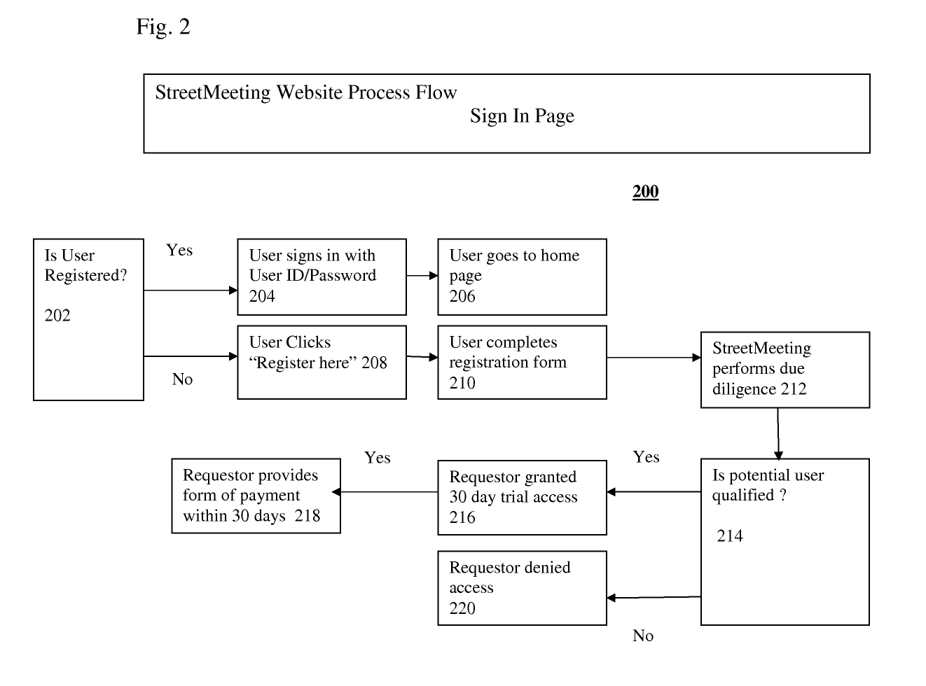

FIG. 2 illustrates a flowchart 200 of a process flow for a sign-in page according to the disclosed embodiments. These steps may be executed at platform 102 within system 100, disclosed above, to allow a user to sign into the website. Further, reference in FIG. 2 and the subsequent figures may be made to elements shown in FIG. 1. The following flowcharts, however, are not limited to the embodiments shown in FIG. 1.

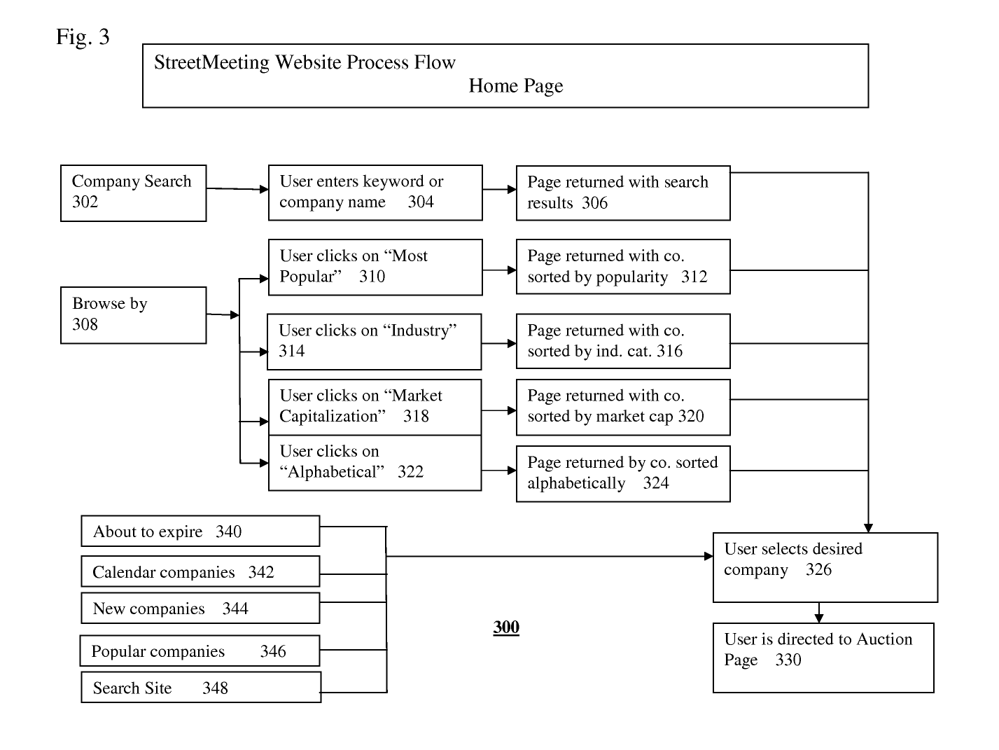

Step 202 executes by determining whether the user is registered. In this instance, a “user” may refer to a buy side firm or company interested in bidding for meetings to facilitate investment opportunities. If yes, then step 204 executes by having the user sign in or log in to the website with a user identification number, name, code or the like and a password. Step 206 executes by having the user go to the home page, which is disclosed in FIG. 3.

If step 202 is no, then step 208 executes by the user clicking or indicating in some manner to “register here” or register on the website. Step 210 executes by the user completing a registration form on the website. According to some embodiments, the user inputs information about the entity looking to access platform 102, and not personal information. The user completes the form by inputting information and then saving this information. Platform 102, for example, may save such information at server 104. A separate information file may be stored in a memory location on server 104.

Step 212 executes by the administrators of system 100, or the people behind the website, perform due diligence on the information provided by the user. Such diligence may be background searches, credit checks, reference checks, company history, financial standing and the like. Step 214 executes by determining whether the potential user is qualified. In other words, step 214 determines whether the potential user is worthy enough to be a buy side firm or company that bids for meeting access or list such meetings. The administrators may set criteria that must be met before being registered to use the auction marketplace. If these criteria are met, then the user is granted access. An algorithm may be executed to provide a value that is used to determine whether the user is allowed access to platform 102. A user failing to meet these criteria may be notified that their request was denied, but informed as to where improvements may be made to be accepted at a later date.

If step 214 is yes, then step 216 executes by notifying the requestor (user) that a 30 day trial access is granted. Step 218 executes by waiting for the requestor to provide a form of payment within 30 days to gain full access to platform 102 to list or bid on meetings. If the requestor fails to pay, then the access granted in step 216 expires after 30 days. If step 214 is no, then step 220 executes by denying the requestor access.

FIG. 3 illustrates a flowchart 300 of a process flow for a home page according to the disclosed embodiments. A user may arrive here after step 206 shown in FIG. 2. Essentially, a user on the home page may select from a variety of actions to perform.

Step 302 executes by performing a company search. Step 304 executes by the user entering a keyword, ticker symbol, company name or the like. Step 306 executes by returning a page with search results based on the entered information. The user may then select the results to receive additional information or go to auctions involving the selected company.

Step 308 executes by performing a browse by function. A user may browse according to several factors, as shown in FIG. 3. Additional factors also may be used for browsing. Step 310 executes by browsing according to a “most popular” factor. Step 312 executes by returning a page with companies sorted by popularity, such as number of searches or active bids. Step 314 executes by browsing according to an “industry” factor. Step 316 executes by returning a page with companies sorted by industry categories.

Step 318 executes by browsing according to a “market capitalization” factor. Step 320 executes by returning a page with companies sorted by market cap size. Step 322 executes by browsing according to an “alphabetical” factor. Step 324 executes by returning a page with companies sorted alphabetically. Other factors may be used for browsing not listed here, but readily available to those skilled in the art.

Step 326 executes by the user selecting a desired company to review. Step 330 executes by directing the user to an auction page pertaining to the desired company or any other criteria.

Steps 340-48 provide other factors to use in selecting companies or meetings to review or bid upon. Step 340 executes by providing a list of companies with bids about to expire. Step 342 executes by providing a list of companies on a calendar of meetings or auctions. Step 344 executes by providing a list of companies that are new companies to system 100 or platform 102. Step 346 executes by providing a list of companies that are popular companies, preferably determined by the dollar amount of bids or cost per bid. Step 348 executes by further searching the disclosed website. All of these results may be available to the user in step 326.

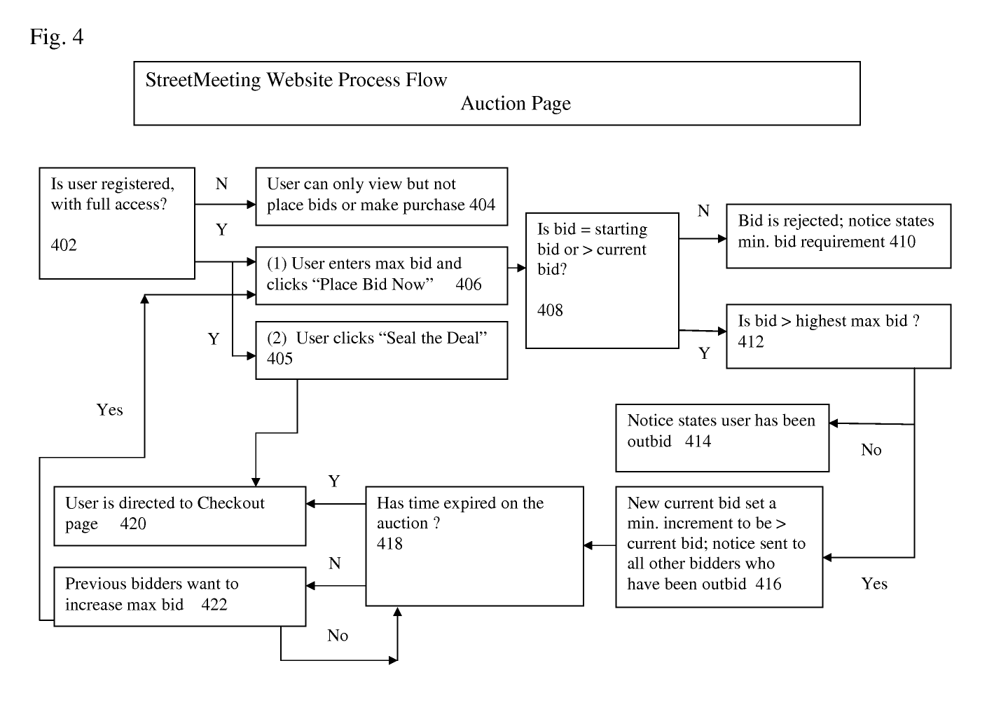

FIG. 4 illustrates a flowchart 400 of a process for an auction page according to the disclosed embodiments. Step 402 executes by determining whether the user looking to bid is registered and has full access. If no, then step 404 executes by allowing the user to view but not place bids or make purchases. If step 402 is yes, then either step 405 or 406 is executed, depending on the user selection. The user may select an option to “seal the deal” to meet the asking price to buy immediately or exercise an option to buy the meeting without further bidding. Seal the deal options may be disabled after a bid is received for the auction.

If step 406 is selected, then the user enters a maximum bid and clicks “place bid now” on the page. Essentially, instead of meeting the price to seal the deal for the meeting, the user is bidding in the auction format. Step 408 executes by determining whether the bid is equal to or greater than the current or starting bid. If no, then step 410 executes by rejecting the bid entered above and notifying the user that bids must meeting minimum bid requirements.

If step 408 is yes, then step 412 executes by determining whether the bid entered above is greater than the highest maximum bid received. If no, then step 414 executes by providing a notifying the user that their bid was outbid. If step 412 is yes, then step 416 executes by setting the new current bid entered above at a minimum increment to greater than current bid. Notice is sent to all other bidders that have been outbid. In an alternate embodiment of the invention, the auction administrator reserves the right to override any determination regarding the winner or highest bidder in the auction. In this embodiment, the auction administrator may have certain guidelines for determining when it is appropriate to override such a determination by the system.

Step 418 executes by determining whether time has expired on the auction. If yes, then control of flowchart 400 goes to step 420, wherein the user is directed to a checkout page. If no, then step 422 executes by determining whether previous bidders on the auction want to increase their maximum bid in light of the new high bid. If no, then flowchart 400 returns back to step 418. If yes, then flowchart 400 returns back to step 406.

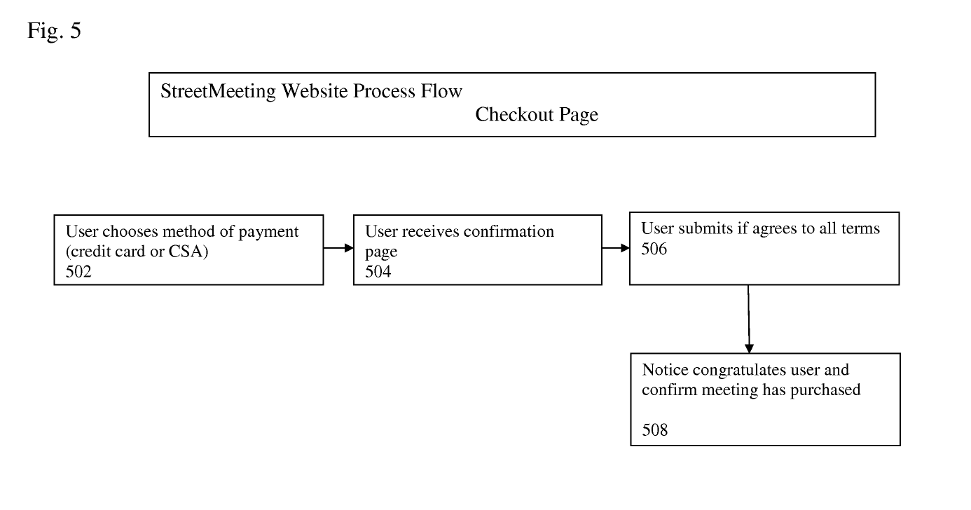

FIG. 5 illustrates a flowchart 500 of a process for a checkout page according to the disclosed embodiments. A winning bidder arrives at the checkout page upon completion of the auction, as shown in FIG. 4. Step 502 executes by the user choosing a method of payment, such as a credit card or an existing account. Step 504 executes by the user receiving a confirmation page that the amount is valid and pertains to the appropriate auction. Step 506 executes by the user submitting the confirmation page if the agrees to all terms. Step 508 executes by sending a notice that congratulates the user and confirms the meeting has been purchases. An additional notice may be sent to the company that the meeting is being held along with contact information for the winning bidder. In this process, the winning bidder also may indicate that it desires a videoconferencing option.

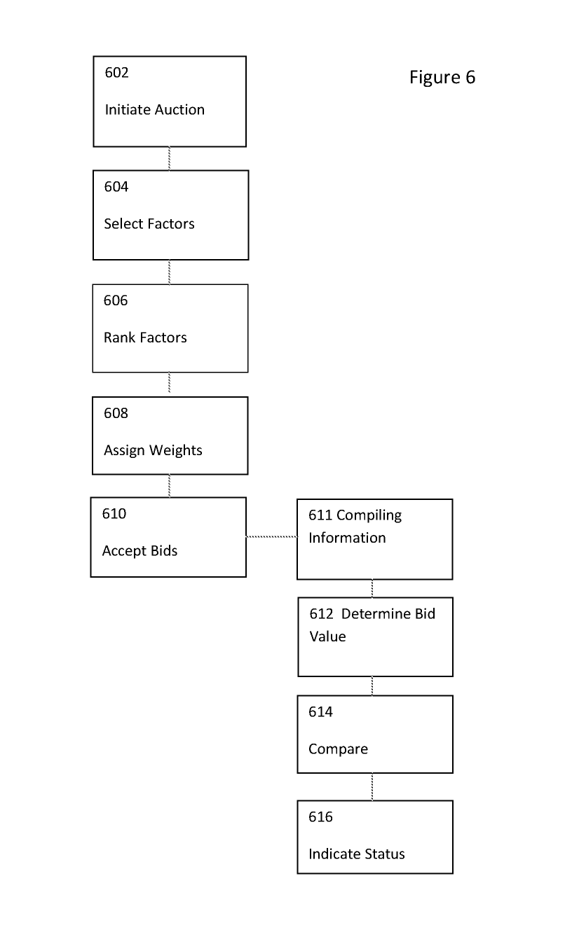

FIG. 6 illustrates a flowchart 600 for determining a bid value according to the disclosed embodiments. FIG. 6 may relate to the steps in FIG. 4 that determine whether a bid is higher than a current bid. In some embodiments, a company selling the meeting may indicate that only the bid price is considered when evaluating a bid. Thus, a bid having a higher value would overtake a current bid having a lesser value. The disclosed embodiments, however, allow for more factors than just price in determining a winning bid.

Step 602 executes by initiating an auction by a corporate client, for example, such as one of companies 120-124. The initiating company agrees to accept bids to engage in meetings with other buy side firms via platform 102. Using platform 102 and the appropriate interfaces, the initiating company sets parameters for the auction, such as start and end dates/times, provides information for potential buy side firms, or bidders, to review, and the like.

Step 604 executes by selecting factors to be considered when evaluating a bid. The initiating company may select from a pre-existing number of factors. These factors also may be created by the initiating company. Examples of such factors include price or maximum bid, size of the bidding buy side firm as measured by assets under management, debt, employees, longevity and the like. Factors also may include information about the previous behavior or capabilities of the bidding buy side firm, such as whether the bidding firm can short sell the stock of the initiating client, whether the bidding firm currently owns stock in the initiating client or parent companies, how long the bidding firm has owned the stock, whether the bidding firm has been adding or reducing their position size, and whether the bidding firm owns competitor's stock. Other factors may include the bidding firm's portfolio turnover rate, the most recent meeting with the bidding firm, any feedback ratings or negative information/criticisms. In accordance with the disclosed embodiments, other factors may be included in the selection process.

Step 606 executes by ranking the selected factors. The initiating company can rank the factors from most to least desired, or vice versa. Step 608 executes by assigning weights to the ranked factors. In this manner, the initiating company may determine how important each factor truly is. For example, if price is the top ranked factor, but not overly important, then it may be assigned a weight of 0.30 out of 1.00. Further, the initiating company may tag factors that it considers informative, but of little importance, by assigning them small values, such 0.01. According to the disclosed embodiments, the weights assigned may add up to any total value.

Step 610 executes by accepting bids along with any other requested information from the bidding buyer side firms. Each user, as disclosed above, goes through the bidding process to submit bids. Submission of bids may occur by a bidding firm simply giving a price as the bid, or may include information for the factors selected. A bidding firm may enter the requested information pertaining to the selected factors during the bidding process. Questions may prompt a bidder to enter the data for each factor. Some prompts may be yes/no questions while other involved data entry, such as amount of shares owned in a company.

Step 611 executes by compiling the information associated with the bids received during the auction process. The information pertains to the factors selected above, or any other information desired by the initiating company. Platform 102 may access computer or computing devices within system 100 of buy side firms 110-114, plus other computing devices, such as databases storing market information 130 or the results from researcher/analysts 132. Platform 102 also may access or save the information in server 104. The information may be compiled without the direct assistance or knowledge of the bidding buy side firm. In fact, platform 102 may retrieve the information from a third party location instead of directly from the bidding buy side firm.

Step 612 executes by determining the submitted bid, or a bid value, according to the selected factors and any weights assigned to the factors. The bid value may be determined by applying the assigned weights to the compiled information to provide a numerical value for each factor. The numerical values are added together to determine the bid value. Other manners of determining a bid value may be used, such as assigning letter grades (“A, B, C,”) to the bids. Other ways of determining a bid value include determining if the selected factors are yes or no, and only accepting those bids have a yes status for each selected factor.

Thus, the bid used in FIG. 4 may not be a straight dollar or currency value, but a combination of the information pertaining to selected factors. The term “bid value” may be substituted for a bid in previous figures. Preferably, the bid value is a number. Step 614 executes by comparing the bid value to the current high bid value according to the process disclosed in FIG. 4. Alternatively, the determined bid value may be ranked with other bids.

Step 616 executes by indicating to the submitting buy side firm that the bid is too low, incomplete, rejected, acceptable, the new high bid, and the like. Thus, the buy side firm may provide an additional bid, seek to improve its bid value by improving factors, or move to another auction.

Thus, an electronic marketplace system is disclosed that allows interested entities to review and bid upon potential meetings with companies. Companies make themselves available to all interested parties and not just those having ties to third party sell side firms.

It will be apparent to those skilled in the art that various modifications and variations can be made in the disclosed embodiments of the privacy card cover without departing from the spirit or scope of the invention. Thus, it is intended that the present invention covers the modifications and variations of the embodiments disclosed above provided that the modifications and variations come within the scope of any claims and their equivalents.

What is claimed is:

1. A computer implemented marketplace auction system comprising:
at least one buy side firm registered to access an auction platform;
at least one company registered to offer a meeting on the auction platform;
an auction process supported by the auction platform, wherein the at least one buy side firm places a bid to purchase the meeting with the at least one company; and
an account configured to receive payment for the bid upon completion of the auction.

2. The computer implemented marketplace auction system of claim 1, further comprising an administrator to register at least one buy side firm or at least one company.

3. The computer implemented marketplace auction system of claim 1, wherein the meeting is a videoconferencing meeting.

4. The computer implemented marketplace auction system of claim 1, further comprising a computing platform configured to receive information pertaining to the bid.

5. The computer implemented marketplace auction system of claim 4, wherein the received information corresponds to at least one factor selected by the at least one company.

6. The computer implemented marketplace auction system of claim 5, wherein the at least one factor includes a weight.

7. The computer implemented marketplace auction system of claim 1, further comprising a computing platform configured to executes an algorithm to determine the bid.

8. A computer implemented method for purchasing meetings between a buy side firm and a company in which the buy side firm invests, the method comprising:
selecting an auction for a meeting with the company;
placing a bid via an auction platform by the buy side firm, wherein the bid pertains to the meeting such that the buy side firm desires to purchase the meeting with the company;
indicating to the buy side firm whether the bid is rejected, too low or a new current bid;
upon completion of the auction after a period of time, notifying the buy side firm whether the meeting has been purchased; and
receiving payment of the bid if the meeting has been purchased.

9. The computer implemented method of claim 8, further comprising the buy side firm selecting the auction from a list of auctions supported by the auction platform.

10. The computer implemented method of claim 8, further comprising selecting at least one factor by the company to comprise the bid.

11. The computer implemented method of claim 10, further comprising assigning a weight to the at least one factor, wherein the weight is applied to information received from the buy side firm.

12. The computer implemented method of claim 11, further comprising determining the bid according to at least one factor and the assigned weight.

13. The computer implemented method of claim 8, further comprising searching for the company in a database accessible by the auction platform.

14. An auction method for purchasing meetings within a system of companies and buy side firms, the auction method comprising:
receiving a plurality of bids for a meeting with a company, wherein the bids are submitted by a respective plurality of buy side firms;
compiling information associated with at least one factor for each of the plurality of bids, wherein the information is stored with linked computing devices or provided by each of the plurality of buy side firms;
determining a bid value for each of the plurality of bids based on the bid, the at least one factor, and the compiled information;
indicating whether the bid value for each of the plurality of bids is rejected, too low or a new current bid;
upon completion of the receiving step after a period of time, notifying a buy side firm that the meeting has been purchased based on the bid value; and
receiving payment associated with the bid value if the meeting has been purchased.

15. The auction method of claim 14, further comprising assigning a weight to the at least one factor.

16. The auction method of claim 15, further comprising applying the weight to the information associated with the at least one factor.

17. The auction method of claim 14, wherein the compiling step includes accessing linked computing devices not controlled by the plurality of buy side firms.

18. The auction method of claim 14, further comprising selecting the at least one factor by the company.
